(19) United States
(12) Patent Application Publication
(10) Pub. No.: US 2015/0178761 A1
(43) Pub. Date: Jun. 25, 2015

(54) System and Method for Personalized Customer Discounts

(71) Applicant: Jetz Convenience Centers, Hales Corners, WI (US)

(72) Inventors: Robert M. O'Connor, Mukwonago, WI (US); Timothy J. Klein, Elm Grove, WI (US)

(21) Appl. No.: 14/576,981

(22) Filed: Dec. 19, 2014

Related U.S. Application Data
(60) Provisional application No. 61/918,094, filed on Dec. 19, 2013.

(51) Int. Cl. G06Q 30/02

(52) U.S. Cl. CPC G06Q 30/0226

(57) ABSTRACT

A loyalty reward program that improves brand loyalty is disclosed. A personalized customer reward is loaded onto a recipient's loyalty reward account by a third party. When the third party loads the reward onto the recipient's loyalty reward account, a customized audio and/or video message is recorded. When the recipient uses their loyalty reward account, the recipient is informed of the reward and receives the personalized message. For example, the loyalty reward program may be for a gas station. When the customer provides their loyalty account identifier at the fuel pump, a notification of the reward may be displayed on a video screen and/or announced via a speaker. Similarly, the customized message is displayed on the video screen and/or played via the speaker as the customer fills their vehicle with gasoline. Receiving the personalized message at the merchant, associates the message with the merchant and builds brand loyalty.

### CROSS-REFERENCE TO RELATED APPLICATIONS

This application claims priority to U.S. provisional application Ser. No. 61/918,094, filed Dec. 19, 2013, the entire contents of which is incorporated herein by reference.

### BACKGROUND OF THE INVENTION

The subject matter disclosed herein relates to a system and method for providing discounts on purchases to a customer. More specifically, a system and method for enhancing brand loyalty by providing personalized messages to customers at a fuel pump during the purchase of gasoline is disclosed.

As is known to those skilled in the art, many merchants provide loyalty reward programs. Customers are enrolled in the reward program and are assigned a personal identifier and may receive, for example, an identification card, key fob, or other device which contains the personal identifier. The device may include an electronic strip or a near-field communication (NFC) transmitter configured to provide the identifier to a point of sale system during a transaction. The point of sale system transmits details of the transaction and the personal identifier to a central server. The central server may store a history of purchases made by the customer and may identify rewards for which the customer has qualified. The central server transmits the rewards back to the point of sale system such that they may be applied to applicable transactions.

Loyalty programs typically provide a uniform discount or a graduated discount, increasing in accordance with the level of purchases made by a customer. For example, a customer at a gas station may receive a five cent per gallon discount on their first fifty gallons of gasoline purchased in a month and a ten cent per gallon discount on any additional gasoline purchased during the month. Optionally, merchants may also periodically provide special offers to customers. For example, a grocery store or a convenience store may include weekly sale items that vary from week to week.

Although such loyalty programs provide financial incentives to a customer to purchase the merchant's products, they do not enhance loyalty to a particular merchant. Customers enroll in the loyalty program for each of the competitors and take advantage of the best incentive offered at any particular time. Thus, it would be desirable to provide a loyalty program that improves brand loyalty, encouraging customers to make most, or all, of their purchases of a product at a single merchant.

As is also known in the art, merchants may offer gift cards for purchase by one customer which, in turn, presents the card as a gift and/or reward to another customer. Gift cards typically include a magnetic stripe including information identifying the card and the amount of money remaining on the card. Gift cards are typically a generic, rectangular plastic card imprinted with the logo of the merchant at which the card may be redeemed. Some cards may include custom graphics or custom shapes to enhance their visual appeal. However, the cards are typically offered in a limited range of graphics and/or shapes and still remain largely generic.

In order to provide customization of gift cards, a merchant may offer custom gift card holders. The gift card holders may include envelopes and cards, allowing a customer to write a personalized message to the recipient. Recent advances in technology have resulted in gift card holders that include storage medium and recording devices such as a microphone and/or a digital camera. Such gift card holders permit a customer to record a short audio and/or video message that may be played by the recipient upon receipt of the gift. However, gift cards require that the recipient carry the card with them and remember to use it. Further, the recorded message, if available, is played upon receipt of the card and creates no connection between the recipient and the merchant. Thus, it would be desirable to provide an improved gifting system.

### BRIEF DESCRIPTION OF THE INVENTION

The subject matter disclosed herein describes a loyalty reward program that provides personalized customer rewards, The personalized customer rewards improve brand loyalty and provide an improved gifting system. A personalized customer reward is loaded onto a recipient's loyalty reward account by a third party. The personalized reward may be, for example, a gift from an individual or a reward associated with a separate purchase from another merchant. When the third party purchaser loads the reward onto the recipient's loyalty reward account, a customized audio and/or video message is recorded. For example, a father or mother may load money onto the account of a son or daughter and record birthday greetings. Alternately, another business may provide a cash rebate for a recent purchase and include a recorded message thanking the recipient for that purchase. When the recipient uses their loyalty reward account, the recipient is informed of the gift or rebate and receives the personalized message. For example, the loyalty reward program may be for a gas station. When the customer swipes their card or passes their key fob by the NFC reader on the point of sale terminal at the fuel pump, a notification of the gift or rebate may be displayed on a video screen and/or announced via a speaker. Similarly, the customized message is displayed on the video screen and/or played via the speaker as the customer fills their vehicle with gasoline. Thus, the customer receives the personalized message at the merchant, associating the message with the merchant and building brand loyalty.

According to one embodiment of the invention, a method for providing personalized customer discounts at a merchant includes receiving a discount and a personalized message from a third party at a server, where the personalized message is associated with the discount The discount and the personalized message are associated with a customer having a loyalty rewards account. An identifier, corresponding to the loyalty rewards account from the customer, is retrieved at a point of sale terminal. The discount and the personalized message associated with the loyalty rewards account are retrieved from the server by the point of sale terminal. The discount is applied to a purchase at the point of sale terminal, and the personalized message is displayed at the point of sale terminal when the purchase is being made.

According to another aspect of the invention, the third party may be an individual and the discount is a prepayment of a good or a service offered by the merchant. Optionally, the third party may be another merchant. The method may include an initial step of completing a qualifying transaction at the other merchant, and the other merchant transmits the discount to the server responsive to the qualifying transaction.

According to yet another aspect of the invention, the point of sale terminal includes a speaker playing the personalized message at the point of sale terminal. Optionally, the point of sale terminal includes a display showing the personalized message on the display.

According to another embodiment of the invention, a system for providing personalized customer discounts is disclosed. The system includes a storage device and a point of sale terminal. The storage device is operable to store multiple first personal identifiers, personalized customer discounts, and personalized messages. Each of the personalized customer discounts corresponds to one of the first personal identifiers, and each of the personalized messages corresponds to one of the personalized customer discounts. The point of sale terminal is operable to process a transaction between a merchant and a customer. The point of sale terminal includes an electronic device operable to receive a second personal identifier from the customer, a network interface operable to communicate with the storage device, and a processor. The processor is operable to transmit the second personal identifier to the storage device and to receive at least one personalized customer discount and the personalized message corresponding to the at least one personalized customer discount from the storage device. The personalized customer discount corresponds to one of the first personal identifiers which matches the second personal identifier. The processor is also operable to apply the personalized customer discount to the transaction and play the personalized message at the point of sale terminal during the transaction.

According to another aspect of the invention, the system may include a server in communication with the storage device. The server is operable to prompt a third party to provide each first personal identifier, personalized customer discount, and personalized message and to store the first personal identifier, personalized customer discount, and personalized message in the storage device.

According to yet another embodiment of the invention, a method for providing personalized customer discounts at a merchant is disclosed. A discount and a personalized message from a third party is received at a server, where the personalized message is associated with the discount. The discount and the personalized message are associated with a customer of the merchant. A point of sale terminal at the merchant receives an identifier corresponding to the customer and retrieves the discount and the personalized message associated with the customer from the server. The discount is applied to a purchase at the point of sale terminal, and the personalized message is displayed at the point of sale terminal when the purchase is being made.

According to another aspect of the invention, the identifier corresponds to a loyalty rewards account for the merchant. Optionally, the identifier corresponds to a phone number, a residential address, or an email address for the customer, and the discount and the personalized message are associated with the identifier.

These and other objects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWING(S)

Various exemplary embodiments of the subject matter disclosed herein are illustrated in the accompanying drawings in which like reference numerals represent like parts throughout, and in which:

FIG. 1 is a block diagram representation of an exemplary retail environment incorporating one embodiment of the invention;

FIG. 2 is an exemplary fuel pump illustrated in FIG. 1;

FIG. 3 is a block diagram representation of an electronic device incorporating one embodiment of the present invention;

FIG. 4 is a flowchart illustrating steps for an individual to provide a personalized reward to another individual according to one embodiment of the invention;

FIG. 5 is a flowchart illustrating steps for a third-party business to provide a personalized reward to a common customer with another merchant offering a loyalty reward program according to one embodiment of the invention; and

FIG. 6 is a flowchart illustrating steps in an individual redeeming a personalized reward from a loyalty reward account according to one embodiment of the invention.

In describing the preferred embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION OF THE PREFERRED EMBODIMENTS

The various features and advantageous details of the subject matter disclosed herein are explained more fully with reference to the non-limiting embodiments described in detail in the following description.

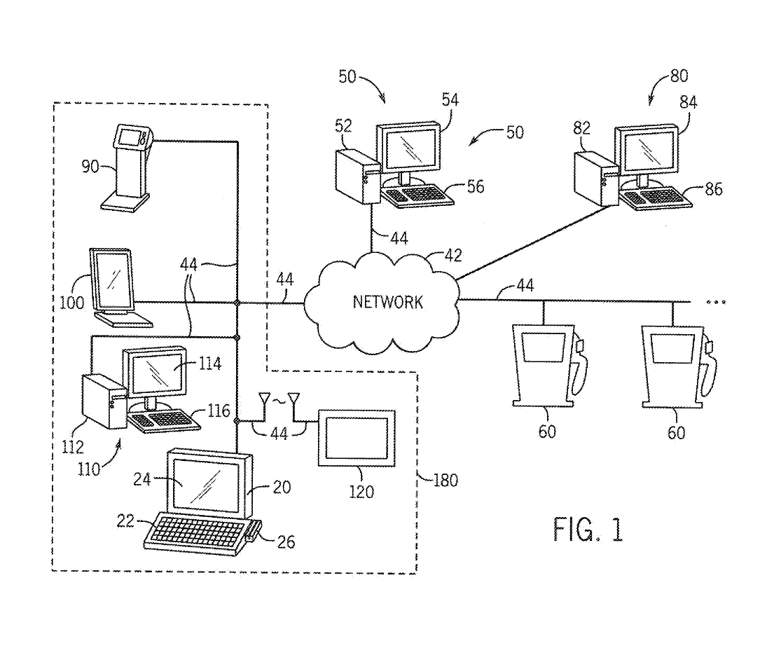

Turning initially to FIG. 1, an exemplary environment, such as a gas station, providing personalized customer discounts according to one embodiment of the invention is illustrated. The gas station may include fuel products for sale outside a convenience store 180 and non-fuel products for sale within the convenience store 180. A network 42, which may include the Internet, an intranet, or a combination thereof, connects devices within the convenience store 180, external yet proximate to the convenience store 180, such as the fuel pumps 60, and computing devices located remotely from the convenience store 180. Network media 44 establishes communication between devices connected to the network 42. The network media 44 may include wired connections, wireless connections, or a combination thereof A central server 50 is connected to the network 42 and includes at least one processing unit 52, a monitor 54, and a user interface 56 such as a keyboard. The central server 50 may be located within the store 180 or, alternately and as illustrated, may be located at a location remote from the store 180. At least one fuel pump 60 is connected to the network 42 outside the store 180, and multiple devices are connected to the network 42 within the store 180. The devices connected to the network 42 within the store may include, but are not limited to: a kiosk 90; a customer monitor 100; a computer station 110 having a processing unit 112, a monitor 114, and a user interface such as a keyboard 116; a point of sale terminal 20; a tablet computer 120, or various combinations thereof. A third party server, computer, or other processing device 80 is in communication with the central server 50 via the network 42 and includes at least one processing unit 82, a monitor 84, and a user interface 86, such as a keyboard.

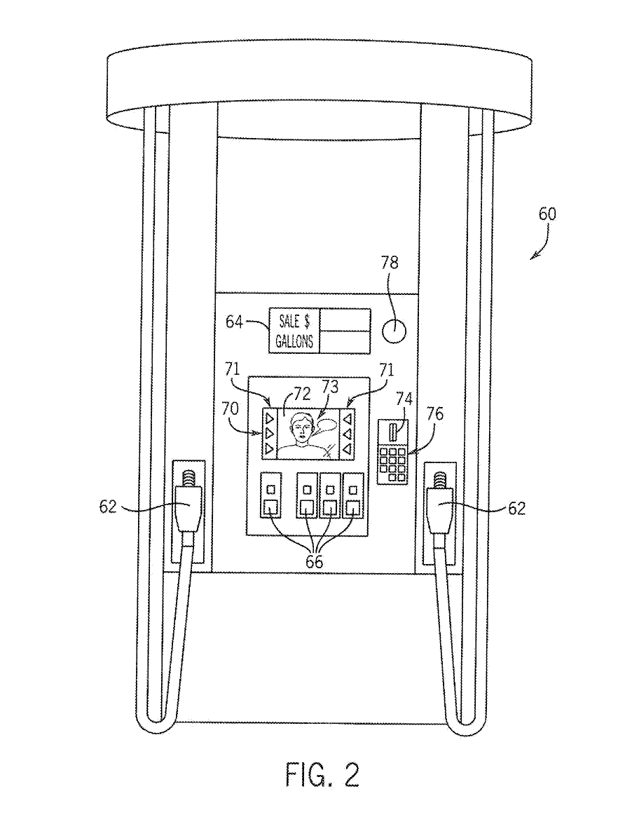

Referring next to FIG. 2, the fuel pump 60 includes one or more nozzles 62 configured to dispense fuel. A display unit 64 provides a visual indication of the amount of fuel dispensed and the corresponding cost for each transaction. Selection buttons 66 allow the customer to select a desired grade and/or type of fuel to dispense from the fuel pump 60. A point of sale terminal 70 is mounted in the fuel pump 60 and includes a display 72. The display 72 may include a plurality of selection buttons 71 oriented along each side of the display 72 to select options presented on the display 72. The fuel pump further includes a magnetic strip card reader 74 to read, for example, credit cards, debit cards, or gift cards for payment or customer loyalty cards to identify the customer. A keypad 76 may allow the customer to enter further information, for example to confirm identity or to respond to a prompt on the display 72. Optionally, a customer may be provided with an NEC device that may be positioned proximate to an NFC reader 78 included in the fuel pump 60 to identify the customer.

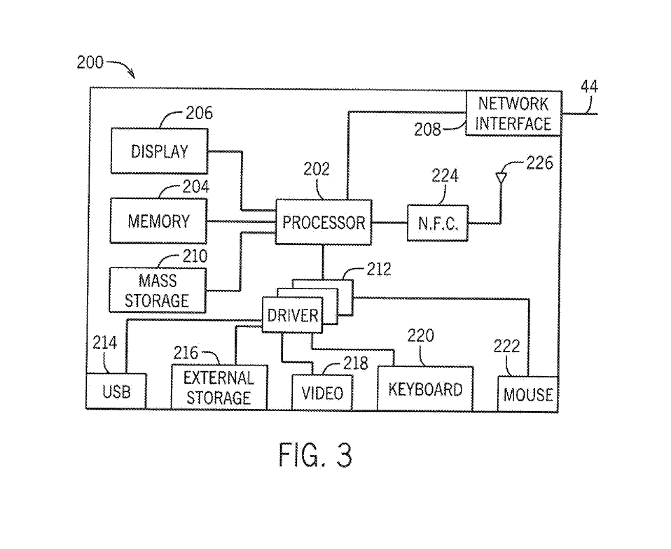

Turning next to FIG. 3, an exemplary processing unit 200 is illustrated. The exemplary processing unit 200 is representative of the Various processing units (e.g., the point of sale terminal 20, the central server 50, the point of sale terminal 70, the third party processing device 80, or the computer station 110) and other devices such as the customer monitor 100 or tablet computer 120 discussed above. Although each of the processing units (20, 50, 70, 80, 110) or other devices (100, 120) may incorporate only a portion of the elements shown in the exemplary processing unit 200, each of the devices includes a processor 202 and a memory device 204 in communication with the processor 202. it is contemplated that the processor 202 may be a single device or multiple devices operating separately or in parallel as is understood in the art. Further, each processor 202 may be a microprocessor, a field programmable gate array (FPGA), application specific integrated circuit (ASIC), a logic circuit, or a combination thereof Each memory device 204 includes one or more devices operating separately or as a single memory unit. The memory device 204 may be persistent, non-persistent, or a combination thereof The memory device 204 stores a series of instructions, or programs, executable by the processor 202. Each of the processing units (20, 50, 70, 80, 110) or other devices (100, 120) further includes a network interface 208 to connect the processor 202 with the network 42 via the network media 44.

According to the application requirements, each of the processing units (20, 50, 70, 80, 110) or other devices (100, 120) may include one or more of the following components as discussed with respect to the exemplary processing unit 200. The exemplary processing unit 200 may include an integrated display 206, a video port 218 to provide a connection to an external monitor, or a combination thereof. A mass storage device 210, such as a magnetic storage device or flash memory, is included in the exemplary processing unit 200. The mass storage device 210 stores, for example, an operating system and application software. The mass storage device 210 may also be used to store other data, such as the discounts, custom messages, and/or loyalty program records according to the system requirements. A plurality of device drivers 212 may also be stored on the mass storage device 210. These device drivers 212 may be executed directly from the mass storage device 210 by the processor 202 or first copied to the memory device 204 to provide faster execution. Each device driver 212 controls execution of a device connected to the exemplary processing unit 200. The devices may include, but are not limited to, a universal serial bus (USB), an external storage device 216, for example, a CD-ROM or DVD-ROM drive, a video port 218, a keyboard or keypad 220, or a mouse 222. The exemplary processing unit 200 may also include an NFC reader 224 connected to an antenna 226. The antenna 226 may be internal or external to the exemplary processing unit 200.

In operation, the system disclosed herein allows a third party to provide a reward to a customer and include a personalized message 73 to accompany the reward. As used herein, the term reward refers to any method of prepaying or agreeing to pay for part or all of a customer's purchase. The reward may also be referred to herein by other terms including, but not limited to a gift, a discount, and a rollback. It is contemplated that the third party may be another individual or a business.

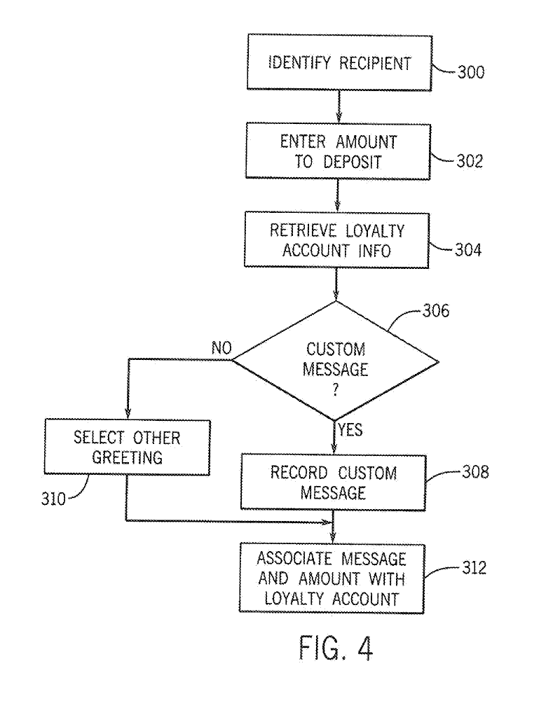

Referring next to FIG. 4, the flowchart illustrates an exemplary process of an individual providing a reward to another individual. At step 300, the individual providing the reward uses a processing device 80, such as a personal computer, a notebook, a tablet, or a personal electronic device such as a smartphone, to identify the intended recipient of the reward. The individual providing the reward also enters a dollar amount into the processing device 80 that they would like to provide to the recipient, as shown in step 302. The processing device 80 is in communication with the central server 50 via the network 42 and transmits the identity of the intended recipient and the desired amount to the central server 50. At step 304, the central server 50 retrieves the loyalty account information based on the identity provided from the processing device 80. According to another embodiment of the invention, a personal identifier for the customer may be provided such as a phone number, residential address, or email address in the event the customer does not have a loyalty account at the service provider. The server 50 and the processing device 80 may also exchange one or more verification messages including, for example, information such as an address, phone number, or other verification information to ensure that the correct individual and corresponding loyalty account has been identified.

The server 50 is configured to allow a personalized message 73 to be provided by the individual providing the reward to the intended recipient. At step 306, the server 50 transmits a message to the processing device 80 via the network 42 inquiring whether the individual providing the reward would like to provide a custom message 73. if the individual would like to provide a custom message 73, the custom message 73 may be recorded with the processing device 80. For example, an individual may use the microphone and camera on a smartphone to record a custom message 73. Optionally, the individual may utilize a web-cam and a microphone connected to a personal computer or notebook computer. According to yet another embodiment, the individual may utilize another device, such as a video recorder to record the custom message 73 and transfer the custom message 73 to the processing device 80. The custom message 73 may be an audio message and/or a video message. The processing device 80 transmits the custom message 73 to the central server 50 where it is associated with the reward and the loyalty account, as shown at step 312. if the intended recipient does not have a loyalty account, the reward may be associated with the personal identifier previously provided such as a phone number, residential address, or email address. If the individual providing the reward does not wish to provide a custom message 73, it is contemplated that the server 50 may have a set of predefined greetings stored. The predefined greetings may be stored, for example, according to an event such as a holiday, birthday, or other event. The individual providing the reward may search the predefined greetings with the processing device and select one, as shown in step 310. The selected greeting is associated with the reward and loyalty account, as shown in step 312.

According to one exemplary instance of an individual providing a reward to another individual, a parent wishes to provide a gift to a child for a birthday, anniversary, or in celebration, of an event such as a promotion or other personal achievement. The parent utilizes his or her smartphone as the processing device 80. The parent may access a website run by the central server 50 or, optionally, load an application onto their processing device 80. The application may perform the communications with the central server 50 and may provide prompts to the parent to enter the required information. The parent enters the name of the child and the dollar amount of the gift into the smartphone. The smartphone transmits the information to the central server 50. The central server 50 retrieves the loyalty reward account information for the child and confirms that identity of the recipient with the parent. Either the website or the application executing on the smartphone may be configured to prompt the parent to enter a custom message 73 for the child. The parent looks into the camera on the smartphone and records a custom message 73 including both an audio and a video component for the child providing birthday or other congratulatory wishes. The custom message 73 and gift are associated with the child's loyalty reward account and stored on the central server 50 for later recall as described in more detail below.

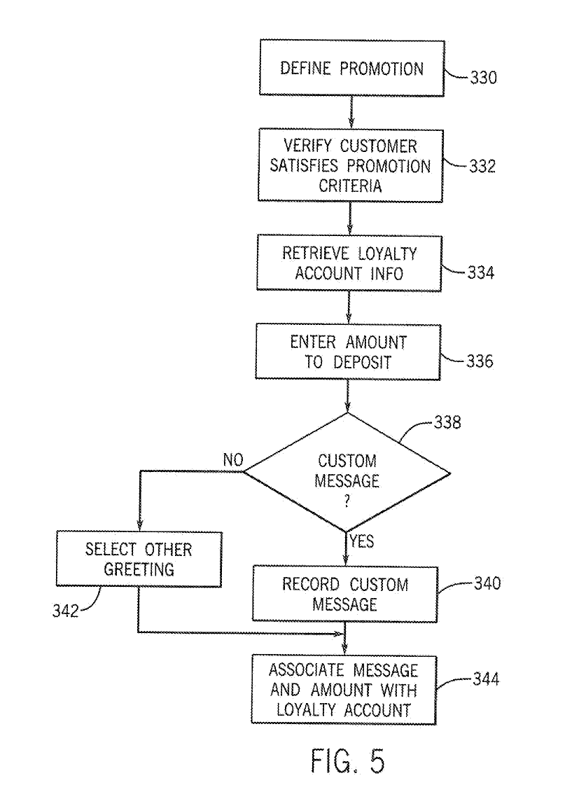

Referring next to FIG. 5, the flowchart illustrates an exemplary process of a third-party business providing a reward to a common customer of that business who also has a loyalty reward account with the first merchant. At step 330, the third-party business defines a promotion using a processing device 80. The processing device may be, but is not limited to, a desktop computer, another server, a notebook, a tablet, or a combination of one or a multiple of the afore-mentioned devices. The promotion may be, for example, a predefined dollar amount rewarded to the common customer upon purchase of merchandise from the third party. At step 332, the third-party enters into the processing device 80 that that the common customer has satisfied the criterion established for the promotion. The processing device 80 is in communication with the central server 50 via the network 42 and transmits the identity of the common customer to the central server 50. At step 304, the central server 50 retrieves the loyalty account information based on the identity provided from the processing device 80. Optionally, another personal identifier for the customer may be provided such as a phone number, residential address, or email address in the event the customer does not have a loyalty account at the first merchant. The server 50 and the processing device 80 may also exchange one or more verification messages, such as an address, phone number, or other verification information to ensure that the correct loyalty account has been identified. At step 336, the third-party business may enter an amount into the processing device 80 that they would like to provide to the common customer, which may be a fixed amount or, for example, a percentage off a future purchase. The processing device 80 transmits the amount of the reward to the central server 50.

The server 50 is configured to allow a personalized message 73 to be recorded by the third party business providing the reward to the common customer. At step 338, the server 50 transmits a message to the processing device 80 via the network 42 inquiring whether the third party business would like to provide a custom message 73. If so, the custom message 73 may be a pre-recorded message, for example, a professionally recorded spot, thanking a customer for purchasing a particular product or it may be recorded with the processing device 80. Optionally, a salesperson may use a microphone and camera connected to the processing device 80 to record a custom message 73 as shown at step 340. The custom message 73 may be an audio message and/or a video message. The processing device 80 transmits the custom message 73 to the central server 50 where it is associated with the reward and the loyalty account, as shown at step 344. If the intended recipient does not have a loyalty account, the reward may be associated with the personal identifier previously provided such as a phone number, residential address, or email address. If the third-party providing the reward does not wish to provide a custom message 73, it is contemplated that the server 50 may have a set of predefined greetings stored. The predefined greetings may be stored, for example, according to an event such as a holiday, birthday, or other event. A representative from the third-party business may search the predefined greetings with the processing device and select one, as shown in step 342. The selected greeting is associated with the reward and loyalty account, as shown in step 344.

According to one exemplary instance of a third-party business providing a reward to a common customer of that business and a first merchant, a home furnishing store defines a promotion in which an individual may receive a graduated cash reward for a gas station according to the value of their purchase at the home furnishing store. The customer may receive a twenty dollar reward for a five hundred dollar purchase and a fifty dollar reward for a thousand dollar purchase. When the customer makes the qualifying purchase, a representative, such as a salesperson, at the home furnishing store enters the information into the processing device 80 at the home furnishing store and is in communication with the central server 50 of the gas station which operates the loyalty reward program. Optionally, the home furnishing store may include an electronic device, such as a card reader or a near field communication (NFC) reader configured to read an identification card or key fob with an NFC transmitter which includes the account identifier for the gas station loyalty reward program. Upon obtaining the loyalty account information from the central server 50 or from the local device, the salesperson enters the amount of the reward to provide to the common customer. The salesperson may select a prerecorded message from the home furnishing store or use a camera and microphone connected to the processing device to record a personal thank you message to the customer for their purchase. The custom message 73 and reward are associated with the customer's loyalty reward account and stored on the central server 50 for later recall as described in more detail below.

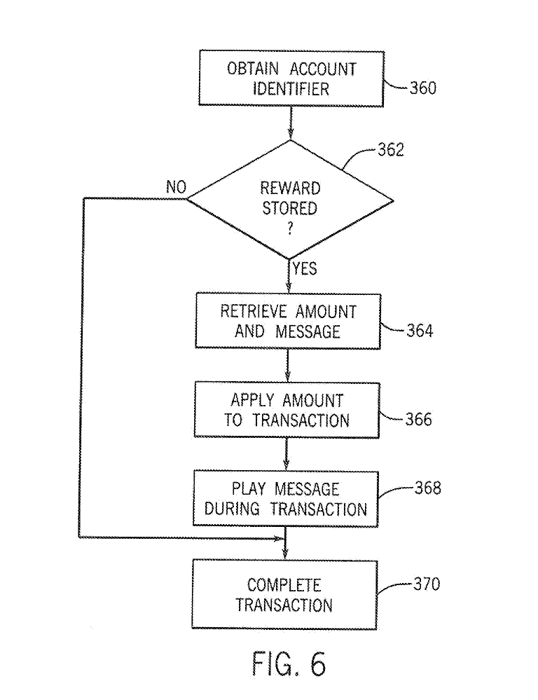

Turning next to FIG. 6, the flowchart illustrates an exemplary process of a recipient redeeming a reward previously stored in their loyalty reward account. The recipient provides an account identifier, as shown at step 360. The account identifier may be encoded in a loyalty program device such as an identification card, which includes a magnetic strip for encoding data or a device with an NFC transmitter and memory for storing data. The customer or an employee of the merchant offering the loyalty rewards program swipes the identification card in a card reader or passes a device, such as a key fob, past an NFC receiver to retrieve the account identifier. Optionally, an employee may manually search for a loyalty account for a customer via a point of sale terminal 20 connected to the central server 50. According to still another embodiment of the invention, the customer may enter the personal identifier such as a phone number, residential address, or email address which was provided by the third party submitting the reward. The account identifier or personal identifier is transmitted to the central server 50 and, at step 362, the central server determines whether a reward associated with the loyalty account or personal identifier has been stored in the central server 50. If no reward has been stored, the transaction may be completed normally, as shown in step 370.

if a reward associated with the loyalty reward account or personal identifier has been stored in the central server 50, the central server 50 may retrieve the reward for use during the transaction. At step 364, the central server 50 retrieves the amount of the reward and the custom message 73 associated with the reward and transmits both to the point of sale. The point of sale may be, for example, a point of sale terminal 20 within a store 180 or a point of sale terminal 70 on a fuel pump 60 external to the store 180. The amount of the reward is applied to the transaction, as shown in step 366 and the custom message 73 is played during the transaction. If the point of sale is within the store 180, the custom message 73 may be displayed, for example, on a customer monitor 100 in communication with the point of sale terminal 20. If the point of sale is at the fuel pump 60, the custom message 73 may be shown on the display 72 of the fuel pump 60.

If the central server 50 identifies multiple rewards associated with a customer loyalty account, the central server 50 retrieves one or more of the rewards according to a predefined set of rules. According to one embodiment of the invention, the central server 50 retrieves the reward having the highest value first and the remaining rewards on subsequent transactions in descending order of value. Optionally, multiple rewards may be applied to a single transaction. Each of the rewards and the associated message is retrieved from the central server 50. The first reward is applied to the transaction and the custom message 73 is played during the transaction. If the cost of the transaction exceeds the first reward, a second reward is applied and the associated custom message 73 is also played during the transaction. According to yet another embodiment of the invention, the central server 50 transmits a list of each reward associated with an account to the point of sale. The list is presented to the customer and the customer may select one or more of the rewards to apply. The customer may utilize, for example, a touch screen on the customer monitor 100 or the selection buttons 71 on the point of sale terminal 70 on the fuel pump 60 to select a reward. It is further contemplated that the point of sale terminal 20 or 70 may first prompt a customer to confirm that they would like to apply a reward and/or hear a custom message 73 prior to applying the amount to the transaction and playing the custom message 73. It is contemplated that still other rules may be predefined within the central server 50 for applying rewards to a transaction without deviating from the scope of the invention.

According to an exemplary embodiment of redeeming an award, the child of the aforementioned gift has a loyalty reward account with a gas station. The parent has provided the child with a gift of fifty dollars for a birthday and recorded a custom message 73 wishing the child a happy birthday. The child arrives at a fuel pump 60 at a gas station and passes a NFC transmitter in front of the NFC reader 78. The point of sale terminal 70 on the fuel pump reads the account identifier from the NFC transmitter and transmits the identifier to the central server 50. The central server 50 retrieves the fifty dollar gift and the custom message 73 previously stored by the parent. As the child begins to pump gas, the custom message 73 is played on the display 72 of the fuel pump 60. When the child is done pumping gas, the fifty dollars is applied to the transaction. if the fifty dollars exceeds the total, the remaining portion of the gift is transmitted back to the central server and stored, along with the custom message 73 for a subsequent transaction. By associating the reward and custom message 73 with a loyalty reward program and playing the custom message 73 during a transaction at the merchant, the customer associates the reward and the custom message 73 with the merchant, enhancing brand loyalty to the merchant.

In each of the afore-described flowcharts, the order of the steps is not intended to be limiting and it is contemplated that many of the steps may be performed in varying orders without deviating from the scope of the invention.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A method for providing personalized customer discounts at a merchant, comprising the steps of:
receiving a discount from a third party at a server;
receiving a personalized message from the third party at the server, wherein the personalized message is associated with the discount;
associating the discount and the personalized message with a customer having a loyalty rewards account for the merchant;
receiving an identifier corresponding to the loyalty rewards account from the customer at a point of sale terminal;
retrieving the discount and the personalized message associated with the loyalty rewards account from the server by the point of sale terminal;
applying the discount to a purchase at the point of sale terminal; and
playing the personalized message at the point of sale terminal when the purchase is being made.

2. The method of claim 1 wherein the third party is an individual and the discount is a prepayment of a good or a service offered by the merchant.

3. The method of claim 1 wherein the third party is another merchant, further comprising an initial step of completing a qualifying transaction at the other merchant, wherein the other merchant transmits the discount to the server responsive to the qualifying transaction.

4. The method of claim wherein the point of sale terminal includes a speaker and playing the personalized message at the point of sale terminal includes playing the personalized message on the speaker.

5. The method of claim 1 wherein the point of sale terminal includes a display and playing the personalized message at the point of sale terminal includes showing the personalized message on the display.

6. The method of claim 1 wherein the identifier corresponds to one of a phone number, a residential address, and an email address for the customer and wherein the discount and the personalized message are associated with the identifier.

7. A system for providing personalized customer discounts, the system comprising:
a storage device operable to store a plurality of first personal identifiers, a plurality of personalized customer discounts, and a plurality of personalized messages, wherein each of the personalized customer discounts corresponds to one of the plurality of first personal identifiers and each of the plurality of personalized messages corresponds to one of the plurality of personalized customer discounts, and
a point of sale terminal operable to process a transaction between a merchant and a customer, the point of sale terminal further including:
an electronic device operable to receive a second personal identifier from the customer,
a network interface operable to communicate with the storage device, and
a processor operable to:
transmit the second personal identifier to the storage device,
receive at least one personalized customer discount and the personalized message corresponding to the at least one personalized customer discount from the storage device, wherein the at least one personalized customer discount corresponds to one of the plurality of first personal identifiers which matches the second personal identifier,
apply the personalized customer discount to the transaction, and
play the personalized message at the point of sale terminal during the transaction.

8. The system of claim 7 wherein the point of sale terminal includes a speaker and playing the personalized message at the point of sale terminal includes playing the personalized message on the speaker.

9. The system of claim 7 wherein the point of sale terminal includes a display and playing the personalized message at the point of sale terminal includes showing the personalized message on the display.

10. The system of claim 7 further comprising a server in communication with the storage device, wherein the server is operable to prompt a third party to provide each first personal identifier, personalized customer discount, and personalized message and to store the first personal identifier, personalized customer discount, and personalized message in the storage device.

11. The system of claim 7 further wherein each of the plurality of first personal identifiers correspond to a loyalty rewards account for the merchant, the system further comprising:
a loyalty program device including the second personal identifier; and
an electronic device configured to read the second personal identifier from the loyalty program device.

12. A method for providing personalized customer discounts at a merchant, comprising the steps of:
receiving a discount from a third party at a server;
receiving a personalized message from the third party at the server, wherein the personalized message is associated with the discount;
associating the discount and the personalized message with a customer of the merchant;
receiving an identifier corresponding to the customer at a point of sale terminal;
retrieving the discount and the personalized message associated with the customer from the server by the point of sale terminal;
applying the discount to a purchase at the point of sale terminal; and
displaying the personalized message at the point of sale terminal when the purchase is being made.

13. The method of claim 12 wherein the third party is an individual and the discount is a prepayment of a good or a service offered by the merchant.

14. The method of claim 12 wherein the third party is another merchant, further comprising the initial step of completing a qualifying transaction at the other merchant, wherein the other merchant transmits the discount to the server responsive to the qualifying transaction.

15. The method of claim 12 wherein the point of sale terminal includes a speaker and playing the personalized message at the point of sale terminal includes playing the personalized message on the speaker.

16. The method of claim 12 wherein the point of sale terminal includes a display and playing the personalized message at the point of sale terminal includes showing the personalized message on the display.

17. The method of claim 12 wherein the identifier corresponds a loyalty rewards account for the merchant.

18. The method of claim 12 wherein the identifier corresponds to one of a phone number, a residential address, and an email address for the customer and wherein the discount and the personalized message are associated with the identifier.
